(19) United States
(12) Patent Application Publication
(10) Pub. No.: US 2022/0219330 A1
(43) Pub. Date: Jul. 14, 2022

(54) TRANSPORT SYSTEM

(71) Applicant: THK CO., LTD., Tokyo (JP)

(72) Inventors: Masaki Nagatsuka, Minato-ku, Tokyo (JP); Yoshiyuki Yamanoue, Minato-ku, Tokyo (JP); Hiroki Sugimura, Minato-ku, Tokyo (JP)

(73) Assignee: THK CO., LTD., Tokyo (JP)

(21) Appl. No.: 17/615,668

(22) PCT Filed: Jun. 1, 2020
(86) PCT No.: PCT/JP2020/021650

§ 371 Date: Dec. 1, 2021

(30) Foreign Application Priority Data
Jun. 4, 2019 (JP) 2019-104698

(51) Int. Cl. B25J 11/00; B25J 5/00; B65G 17/26

(52) U.S. Cl. CPC B25J 11/0045; B65G 17/26; B25J 5/007

(57) ABSTRACT

A transport system comprising a manipulator device and a housing device. The manipulator device has a hand capable of grasping target objects. The hand position can be controlled relative to a manipulator main body section which is the main body section of the manipulator device. The housing device has a housing section capable of housing a plurality of target objects. The housing device is configured so as to carry the target objects housed in the housing section, one at a time, to a prescribed position accessible by the hand. The manipulator device and the housing device are configured so as to travel as an integrated unit in which the manipulator main body section and the housing device are coupled. The prescribed position is set at a known position using the manipulator main body section as a reference in which the manipulator main body section and the housing device are coupled.

### TECHNICAL FIELD

The present invention relates to a transport system that transports objects.

### BACKGROUND ART

Nowadays, robots have been widely used in daily life. For example, Patent Literature 1 discloses a robot that transports objects such as food and drink to users. The robot has a tray on which an object is placed. The robot moves to a user with an object placed on the tray to transport it to the user. It is not easy for transport systems using such a robot to transport many objects at a time. When transporting an object, the speed of the robot is greatly limited to prevent adverse effects (e.g. vibrations or toppling) on the object during transport.

Examples of a system for transporting objects are food service carts disclosed in Patent Literatures 1 and 2. These food service carts can accommodate many objects (e.g. food and drink to be served to users) at a time. They are provided with a lifter inside them to facilitate taking out objects from them. The food service carts are adapted to allow objects housed therein to be taken out through a certain doorway. Patent Literature 4 discloses a wheelchair provided on one side with a housing rack having a lifting function to allow the user of the wheelchair to serve trays of food and drink smoothly.

### CITATION LIST

### Patent Literature

Patent Literature 1: Publication of Chinese Patent Application No. 108527378
Patent Literature 2: Publication of Japanese Utility Model No. S58-18749
Patent Literature 3: Japanese Utility Model Application Laid-Open No. S62-203781
Patent Literature 4: Japanese Patent No. 5903449

### SUMMARY OF INVENTION

### Technical Problem

Multi-functionality of robots are of interest to many people, and a variety of their use in daily life have been developed. As described above, use of robots in various situations of transporting objects such as food and drink have been studied. In particular, robots can be employed usefully in situations of transporting many objects, taking out the objects from a housing and passing them to a user at a destination. To cause a robot to execute such useful operations, it is necessary to control the robot precisely. For example, various processing is needed, such as detailed recognition of objects and positioning for allowing a hand unit of the robot, such as an end effector, to perform a holding operation. Such processing is not easy or simple to execute in most cases.

The present invention was made to address the above problem, and an object of the present invention is to provide a transport system capable of transporting object appropriately.

### Solution to Problem

To solve the above problem, according to the present invention, a manipulator apparatus having a hand unit for holding an object and a housing apparatus in which a plurality of objects are housed are configured to be capable of moving in a state in which they are coupled together, and the object is brought to a predetermined specific position in the housing apparatus so that the object is accessible for the hand unit. This configuration enables the hand unit of the manipulator apparatus to hold the object by simple control.

More specifically, according to the present invention, there is provided a transport system comprising a manipulator apparatus having a hand unit capable of holding an object and a housing apparatus having a housing unit capable of housing a plurality of said objects, wherein the manipulator apparatus is configured to be capable of controlling the position of the hand unit relative to a manipulator body unit that constitutes a main body of the manipulator apparatus, and the housing apparatus is configured to bring the objects housed in the housing unit one by one to a specific position in the housing apparatus accessible for the hand unit. The manipulator apparatus and the housing apparatus are configured to be capable of moving as a unit in a state in which the manipulator body unit and the housing apparatus are coupled with each other. The specific position is set as a known position relative to the manipulator body unit in the state in which the manipulator body unit and the housing apparatus are coupled with each other to make the manipulator apparatus and the housing apparatus integral.

### Advantageous Effects of Invention

The present invention can provide a transport system that can achieve favorable transport of an object.

### BRIEF DESCRIPTION OF DRAWINGS

FIG. 1 is a diagram illustrating the general structure of a transport system.

FIG. 2 is a first diagram illustrating the general structure of a robot included in the transport system.

FIG. 3 is a second diagram illustrating the general structure of the robot included in the transport system.

FIG. 4 is a third diagram illustrating the general structure of the robot included in the transport system.

FIG. 5 is a diagram illustrating joint axes in the robot.

FIG. 6 is a diagram illustrating the general configuration of a housing apparatus included in the transport system.

FIG. 7 is a diagram illustrating the general configuration of a housing rack included in the housing apparatus illustrated in FIG. 6.

FIG. 8 is a diagram illustrating the structure of a chain included in the housing rack illustrated in FIG. 7.

FIG. 9 is a diagram illustrating the structure of a tray rest included in the housing rack illustrated in FIG. 7.

FIG. 10 is a diagram specifically illustrating a portion of the housing rack.

FIG. 11 is a functional block diagram of the transport system.

FIG. 12 is a first flow chart of an object transport process executed in the transport system.

FIG. 13 is a second flow chart of an object transport process executed in the transport system.

### MODE FOR CARRYING OUT THE INVENTION

A transport system according to an embodiment is constituted by a combination of a manipulator apparatus having a hand unit capable of holding an object and a housing apparatus capable of housing a plurality of objects. The hand unit of the manipulator apparatus may be of any type, so long as it is capable of holding an object. For example, a mechanism configured to hold an object between a plurality of fingers may be employed as the hand unit. Alternatively, the hand unit may be configured to hold an object by aspiration or suction. The manipulator apparatus includes a manipulator body unit that constitutes the main body of the manipulator apparatus and the hand unit, and the manipulator apparatus is configured to be capable of controlling the position of the hand unit relative to the manipulator body unit. Therefore, it is possible to position the hand unit relative to the object and to move the object held by the hand unit. The mechanism used to move the hand unit relative to the manipulator body unit is not limited to any particular mechanism. For example, this mechanism may be a system that moves the hand unit by a link mechanism composed of a plurality of links or an arm mechanism having a plurality of joints.

The manipulator apparatus may be constructed as, for example, a robot including a robot main body constituting the manipulator body unit, a first arm unit having a first hand unit constituting a first example of the aforementioned hand unit, the first arm unit being configured to be capable of controlling the position of the first hand unit relative to the robot main body, and a second arm unit having a second hand unit constituting a second example of the aforementioned hand unit, the second arm unit being configured to be capable of controlling the position of the second hand unit relative to the robot main body. The manipulator apparatus may include a further (third or more) arm unit.

The housing apparatus can house a plurality of objects in its housing unit. The housing apparatus is configured to bring the objects housed in it to a specific position one by one. This specific position is a position in the housing apparatus accessible for the hand unit. Thus, an object brought to the specific position can be held by the hand unit, and then the object held by the hand unit can be moved to a desired position by position control performed by the hand unit and the manipulator body unit.

The transport system having the above-described construction is configured such that the manipulator body unit and the housing apparatus are coupled with each other so that the manipulator apparatus and the housing apparatus can move integrally as a unit. Thus, the manipulator apparatus and the housing apparatus can move together to a place to which an object is to be transported with a plurality of objects housed in the housing unit, and one, some, or all of the objects housed therein can be taken out by the manipulator apparatus at that place.

In the transport system, the specific position is set as a known position relative to the manipulator body unit in the state in which the manipulator apparatus and the housing apparatus are coupled integrally as described above. In consequence, when the operation of holding an object is performed, the positional relationship of the manipulator apparatus and the housing apparatus is fixed. Hence, the object to be held is always positioned at the known position (or the specific position) as seen from the manipulator body unit. This helps simplification of the position control of the hand unit by the manipulator apparatus. Specifically, since the relative positional relationship of the specific position is known, it is not necessary to recognize (or determine) the position of the object specifically when holding it by the hand unit, or the processing of recognizing the position of the object can be made simpler. This leads to a reduction of the operation load in the process of taking out objects from the housing unit one by one. In consequence, this system can achieve favorable transport of objects.

In the following, a specific embodiment of the present invention will be described with reference to the drawings. In should be understood that the dimensions, materials, shapes, relative arrangements, and other features of the components that will be described in connection with the embodiment are not intended to limit the technical scope of the present invention only to them, unless particularly stated.

### <Configuration of Transport System 1>

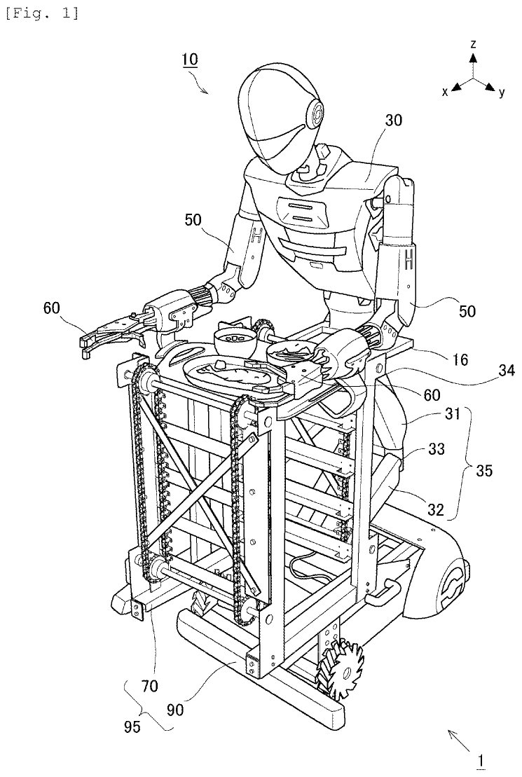

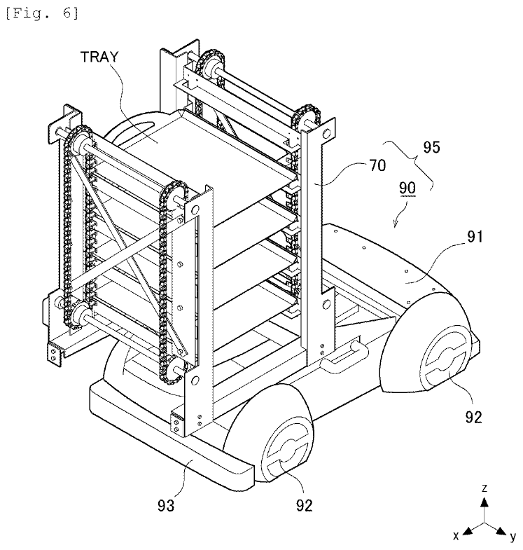

The general configuration of a transport system according to an embodiment will be described with reference to FIG. 1. The transport system 1 includes a robot 10 corresponding to the manipulator apparatus according to this disclosure and a housing apparatus 95. The robot 10 has a robot main body 30, two arm units 50 attached to the robot main body 30, a pelvis unit 16 included in the robot main body 30, and a leg unit 35 attached to the pelvis unit 16 and extending downward. Details of the robot 10 will be described later. To the end of each arm unit 50 is attached a hand unit 60 used to hold an object. The housing apparatus 95 has a housing rack 70 corresponding to the housing unit according to this disclosure and a truck 90. The truck 90 has a pedestal 91 (see FIG. 6 mentioned later), and the robot 10 is mounted on the pedestal 91. Thus, the robot 10 and the housing apparatus 95 integrally constitute a transport system 1.

If it is assumed in this embodiment that the direction of travel of the truck 90 in the transport system 1 (namely, the frontward direction of the robot 10) is the positive direction of the X axis, the leftward direction of the truck 90 (or the robot 10) is the positive direction of the Y axis, and the anti-gravity direction (i.e. the direction opposite to the gravity) of the truck 90 (or the robot 10) is the positive direction of the Z axis, the X axis is the roll axis, the Y axis is the pitch axis, and the Z axis is the yaw axis. In consequence, rotation about the X axis is roll rotation (or leftward or rightward rotation), rotation about the Y axis is pitch rotation (or frontward or rearward rotation), and rotation about the Z axis is yaw rotation. In the context of this embodiment, the upward direction is the positive direction of the Z axis or the anti-gravity direction, and the downward direction is the negative direction of the Z axis or the direction of gravity. The leftward and the rightward directions refer respectively to the leftward and the rightward directions seen from the truck 90 (or the robot 10); the positive direction of the Y axis is the leftward direction, and the negative direction of the Y axis is the rightward direction.

### <Structure of Robot 10>

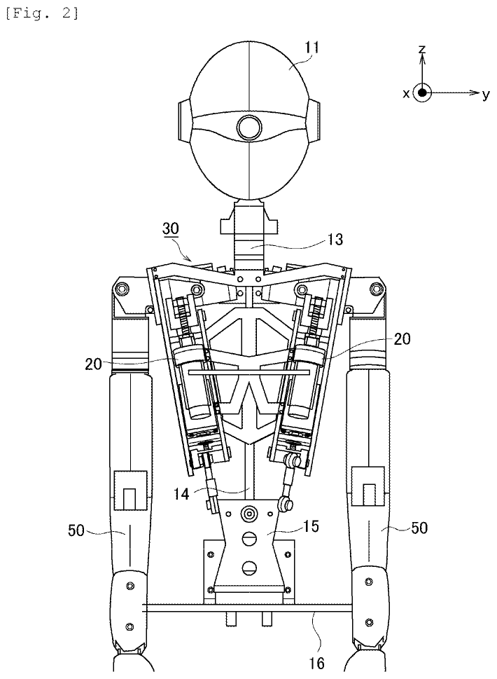

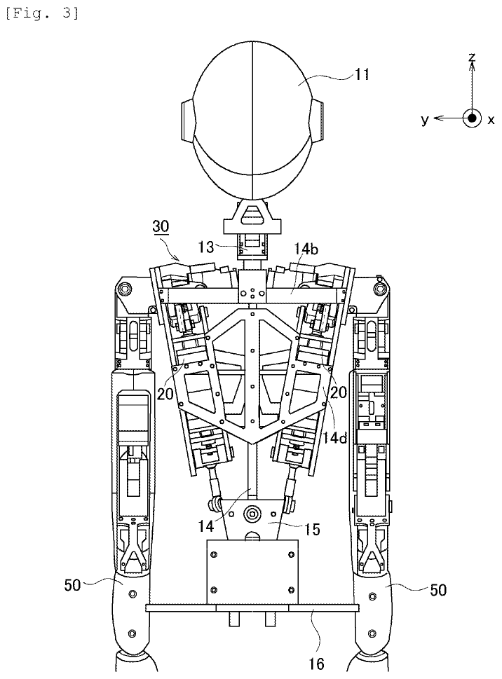

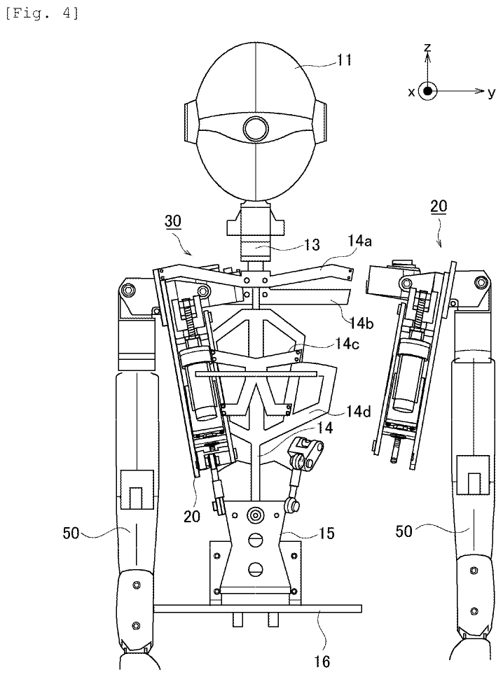

The general structure of the robot 10 will be described next with reference to FIGS. 2 to 4. FIG. 2 is a front view of the robot 10, and FIG. 3 is a rear view of the robot 10. FIG. 4 is a diagram illustrating the robot 10 in a partially disassembled state. In these drawings, the robot 10 is illustrated without its body cover to make its interior structure visible. The robot 10 is a humanoid robot, which has a body that mimics the human bone structure. The body is the bone structure of the upper body of the robot 10, which constitutes the robot main body 30 illustrated in FIG. 2. The robot main body 30 is mainly composed of a spine unit 14 extending along the Z axis in FIG. 2, bone units 14a to 14d made of metal plates, which will be described later, a hipbone unit 15 coupled to the spine unit 14 to support it, and a pelvis unit that supports the hipbone unit 15 and to which the leg unit 35 is connected. The arm units 50 and the leg unit 35 are attached to this robot main body 30. To the spine unit 14 is connected a neck unit 13 of the robot 10, on the top of which a head unit 11 is mounted. The head unit 11 may be provided with a camera that captures images of its environment. The head unit 11 and the spine unit 14 are connected via the neck unit 13 in such a way as to allow roll, pitch, and yaw rotations of the head unit 11 relative to the spine unit 14.

The robot 10 is provided with drive units 20 for driving the right and left upper bodies of the robot 10 respectively. The drive unit 20 includes an actuator used to rotate the arm unit 50 of the robot 10 in pitch and roll directions on the shoulder of the robot 10. As illustrated in FIG. 4, a front collarbone unit 14a and a back collarbone unit 14b are connected to the spine unit 14 at the location of the shoulder of the robot 10 respectively on the front and the back of the robot 10. Moreover, a front breastbone unit 14c and a back breastbone unit 14d are connected to the spine unit 14 at the location of the breast (below the shoulder) of the robot 10 respectively on the front and the back of the robot 10. These bone units 14a to 14d and the spine unit 14 form spaces on the right side and the left side of the spine unit 14 in the upper body of the robot 10. The two drive units 20 are housed respectively in the right and left spaces and connected to the bone units 14a to 14d. Thus, the two drive units 20 are provided inside the robot 10. Since the bone units 14a to 14d are made of metal plates, the drive units 20 are attached to the spine unit 14 relatively elastically. The drive units 20 are also connected to the hipbone unit 15. The hipbone unit 15 is supported by the pelvis unit 16.

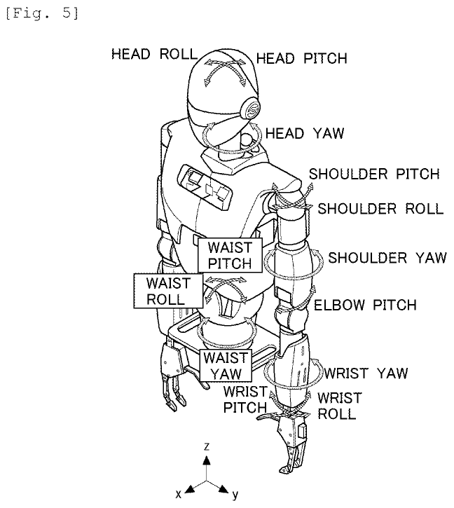

In the upper body structure of the robot 10 configured as above, various drive axes are defined as illustrated in FIG. 5. Among them, drive axes relating to the head unit 11 include a head roll axis, a head pitch axis, and a head yaw axis. Actuators are provided for the respective axes so that the head unit 11 can rotate in the roll, pitch, and yaw directions relative to the neck unit 13. Drive axes relating to the hipbone unit 15 include a waist roll axis, a waist pitch axis, and a waist yaw axis. Actuators are provided for the respective axes so that the upper body of the robot 10 can rotate in the roll, pitch, and yaw directions relative to the hipbone unit 15. Drive axes relating to the arm unit 50 include a shoulder roll axis, a shoulder pitch axis, a shoulder yaw axis, an elbow pitch axis, a wrist roll axis, a wrist pitch axis, and a wrist yaw axis (seven axes in total). Actuators are provided for the respective axes so that the arm unit 50 of the robot 10 can rotate in the roll, pitch, and yaw directions at the shoulder, in the pitch direction at the elbow, and in the roll, pitch, and yaw directions at the wrist. As will be understood from the above structure, the arm unit 50 of the robot 10 has a structure mimicking the human arm. The arrangement and the structure of the actuators for the respective axes are known in the art, and therefore they will not be described specifically in this disclosure.

As illustrated in FIG. 1, the leg unit 35 is attached to the pelvis unit 16 and extending downward. The leg unit 35 is configured to support the above-described upper structure of the robot 10. Specifically, the leg unit 35 includes an upper leg link unit 31 and a lower leg link unit 32. The lower leg link unit 32 is fixed to the pedestal 91 of the truck 90. Thus, the robot main body 30 and the housing apparatus 95 are coupled via the leg unit 35. The upper leg link unit 31 and the lower leg link unit 32 are connected by a knee joint unit 33 having an actuator in such a way as to be capable of rotating in the pitch direction. The upper leg link unit 31 and the pelvis unit 16 are connected by an under-waist joint unit 34 having an actuator in such a way as to be capable of rotating in the pitch direction. The height of the upper body structure of the robot 10 can be changed by cooperative pitch rotations of the knee joint unit 33 and the under-waist joint unit 34 while maintaining its posture.

### <Structure of Housing Apparatus>

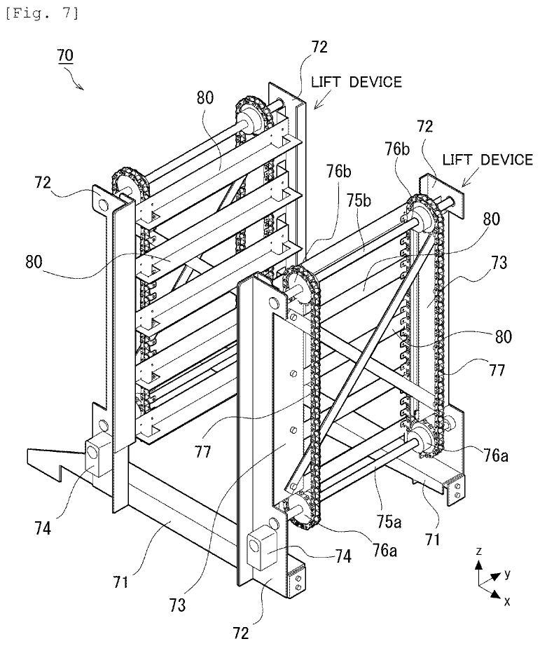

The general structure of the housing apparatus 95 will be described next with reference to FIGS. 6 and 7. FIG. 6 is a diagram illustrating the general structure of the housing apparatus 95, and FIG. 7 is a diagram illustrating the general structure of the housing rack 70 provided in the housing apparatus 95. The housing apparatus 95 includes the housing rack 70 and the truck 90. It is possible to arrange a plurality of trays in the housing rack 70 along the vertical direction (or the Z axis direction) one above another, as illustrated in FIG. 6. The trays are objects to be held by the hand units 60. The trays may be arranged in the housing rack 70 with food and drink to be served to users placed thereon. The truck 90 has four drive wheels 92. The truck 90 also has a bumper 93 on its front side to reduce the impact upon collision. The housing rack 70 is provided on the front portion of the upper surface of the truck 90, and the pedestal 91 is provided on the rear portion of the upper surface of the truck 90 to serve as a place on which the robot 10 is disposed behind the housing rack 70.

Next, the housing rack 70 will be described with reference to FIG. 7. The housing rack 70 has a pair of base members 71 mounted on the truck 90 and extending along the X axis. The housing rack 70 also has four support columns 72 fixed on the base members 71 and extending along the Z axis. Two pairs of supporting columns 72 among the four support columns 72 that respectively define YZ planes are used to construct two lift devices. More specifically, the housing rack 70 has a lift device constructed in a first YZ plane and another lift device constructed in a second YZ plane spaced from the first YZ plane along the X axis, both of which are mounted on the pair of base members 71. Trays to be held are placed in such a way that the ends of each tray rest on a tray rest 80 of one lift device and a tray rest 80 of the other lift device. Thus, the trays housed in the housing rack 70 are arranged one above another along the vertical direction.

The lift devices of the housing rack 70 will now be described below. Since the two lift devices of the housing rack 70 have the same structure, only one of them will mainly be described. One lift device has an actuator 74 provided on the lower portion of one of the support columns 72. The actuator 74 is used to move up and down a plurality tray rests 80 that are arranged one above another between one support column 72 and the other support column 72. The output shaft of the actuator 74 is connected to a lower rotary shaft 75a via a transmission mechanism (e.g. gears) not shown in the drawings, the lower rotary shaft 75a being extending between the lower portions of the two support columns and rotatably supported thereon. To the lower rotary shaft 75a are attached two sprockets 76a for the respective support columns. There is also provided an upper rotary shaft 75b extending between the upper portions of the two support columns 72 and rotatably supported thereon. To the upper rotary shaft 75b are also attached two sprockets 76b for the respective support columns. Chains 77 are wrapped around the lower sprockets 76a and the upper sprockets 76b for the two columns 72. With this structure, the drive force of the actuator 74 is transmitted to the lower rotary shaft 75a and then to the upper rotary shaft 75b by the chains 77. There is also provided flat guide plates 73 extending in the vertical direction along the respective support columns.

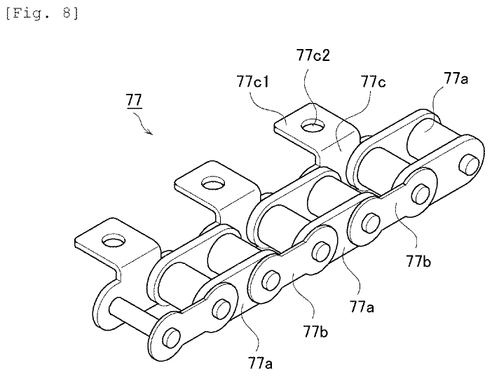

The structure of the chain 77 will now be described with reference to FIG. 8. The chain 77 is composed of a plurality of roller chains 77a that are connected by links 77b, 77c. As illustrated in FIG. 8, the links 77c on one side of the chain 77 are flanged links on which the tray rests 80 are to be attached. Specifically, the flanged link 77c has a flange 77cl that is angled perpendicular to a flat portion that connects roller chains 77a. The flange 77cl has a through hole 77c2. The through hole 77c2 is used to attach the tray rest 80. It is not necessary to provide the flanged links 77c on all the roller chains 77a of the chain 77. It is preferred that the flanged links 77c be provided continuously along approximately half the circumference of chain 77.

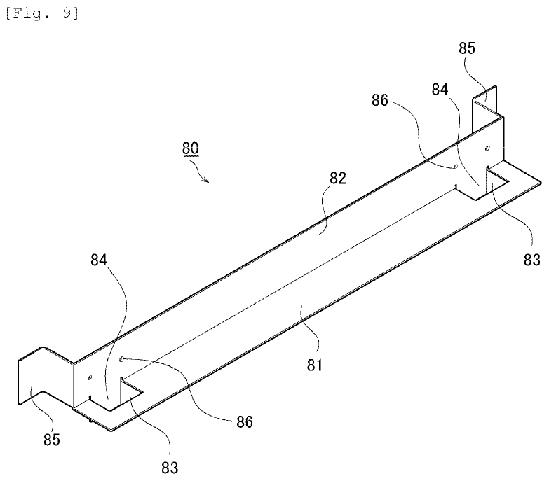

Next, the structure of the tray rest 80 will be described with reference to FIG. 9. The tray rests 80 are used to house a plurality of trays in the housing rack 70 by supporting the opposite ends of the trays on them. The tray rests 80 are arranged in such a way that one tray is supported by a pair of support rests 80 in the housing rack 70. This pair of tray rests 80 corresponds to the table part according to this disclosure. The tray rest 80 has a table plate 81 on which an end of the tray is to be placed and a back plate 82 that is angled approximately perpendicular to the table plate 81. The back plate 82 has through holes 86 near its both ends, which are used to attach the tray rest 80 to the chain 77. Specifically, the tray rest 80 is attached to the two chains 77 with the through hole 86 near one end of the tray rest 80 being aligned with a through hole 77c2 of one chain 77 and with the through hole 86 near the other end of the tray rest 80 being aligned with a through hole 77c2 of the other chain 77. To the back plate 82 are connected retaining plates 84 at locations below the through holes 86 provided near the ends of the back plate 82. The retaining plates 84 and the back plate 82 are coplanar. The table plate 81 has a cut portion 83 having the same shape as the retaining plate 84. When the tray rest 80 is being attached to the two chains 77, the retaining plates 84 are located in such a way as to retain the chains 77. This can prevent the chains 77 in the housing rack 70 from loosening, and therefore the chains 77 can transmit the driving force of the aforementioned actuator 74 reliably.

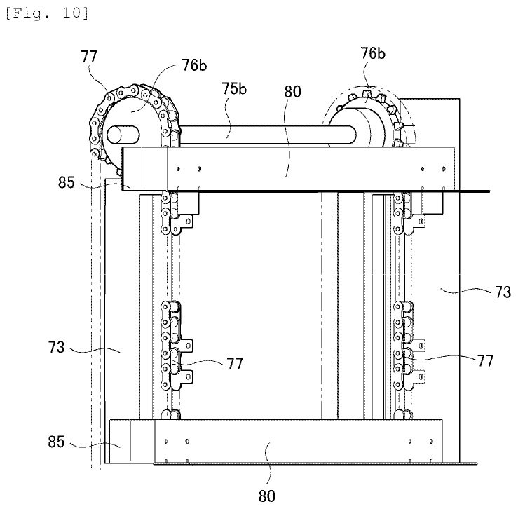

The tray rest 80 has guide portions 85 bent in a crank-like shape and extending from both ends of the back plate 82. The guide portion 85 has a surface that is substantially parallel with the back plate 82 and spaced from the back plate 82 on the side opposite to the table plate 81. In the state in which the tray rest 80 is being attached to the two chains 77, the guide portions 85 are in surface contact with two side guide plates 73 disposed respectively along the two support columns 72 as illustrated in FIG. 10. The frictional force acting between the guide portions 85 and the guide plates 73 with their surface contact is small enough not to substantially affect driving of the chains 77 by the actuator 74. The surface contact of the guide portions 85 and the guide plates 73 on both the ends of the tray rest 80 can prevent inclination of the tray rest 80 while the tray is moved up and down, thereby preventing food or drink on/in a dish, cup or other containers on the tray from spilling and preventing the containers from toppling over.

The operation of the housing rack 70 structured as above will now be described. As described above, the housing rack 70 has two lift devices, and the tray rests 80 attached to the respective lift devices are opposed to each other (see FIG. 7). With this arrangement, a tray is placed with its ends supported on the tray rest 80 of one lift device and the opposed tray rest 80 of the other lift device (see FIG. 6). As illustrated in FIGS. 6 and 7, the two lift devices of the housing rack 70 are spaced from each other by a distance slightly larger than the width of the tray. When a plurality of trays are to be housed in the housing rack 70, the space between the lift devices may be utilized to slide the trays into the housing rack 70 from the direction of the Y axis. FIG. 6 shows a state in which four trays are housed in the housing rack 70.

When the hand units 60 of the robot 10 hold a tray housed in the housing rack 70 to take it out, the hand units 60 of the two arm units 50 hold the Y-axial ends of the tray and lift up the tray they hold. In order for the hand units 60 to do this operation, it is necessary that the tray to be held be the tray that is located uppermost in the housing rack 70 and that tray rests 80 that are not for the tray to be held (e.g. tray rests 80 on which another tray was being placed) are not located above the tray to be held. This is because if such tray rests 80 are located above the tray to be held, the tray held and lifted up by the hand units 60 may interfere with such tray rests 80, whereby the tray may be prevented from being taken out smoothly.

The system according to this embodiment is configured to control the position of the tray in the housing rack 70 such that the tray to be held satisfies the above condition. Details of this control will be described later. This position of the tray corresponds to the specific position according to this disclosure. This position will be referred to as the “tray holding position”. The tray holding position is a fixed position determined in advance in the housing rack 70. As descried above, the truck 90 and the housing rack 70 mounted thereon constitute the housing apparatus 95, and the robot 10 is fixed on the truck 90. Thus, the housing apparatus 95 and the robot 10 integrally constitute the transport system 1. In consequence, in this transport system 1, the tray holding position is a known position relative to the robot main body 30 of the robot 10. Therefore, when the holding operation is done by the hand units 60 of the two arm units 50 of the robot 10, it is not necessary to recognize (or determine) the position of the tray specifically, or the processing of recognizing the position of the tray can be made simpler. This leads to a reduction of the operation load in the process of taking out trays from the housing rack 70 one by one by the robot 10. In consequence, the control of the position of the hand units 60 by the robot 10 can be made simpler, and favorable transport of the trays can be achieved.

The transport system 1 including the robot 10 and the housing apparatus 95 configured as above can be moved by the truck 90 with the robot 10 to a destination of transport of the objects with a plurality of trays (or objects) being housed in the housing rack 70 of the housing apparatus 95. After arriving at the destination, the transport system 1 can execute the operation of delivering the trays to a user(s) by holding and taking out the trays precisely with a simple position control of the hand units 60. To enable the transport of trays by the transport system 1, the robot 10 and the housing apparatus 95 are provided with respective control devices 10A, 95A. The control devices 10A, 95A are computers each having a calculation device and a memory. The control devices 10A, 95A execute certain control programs to perform the above-described transport process. The control devices 10A and 95A are electrically connected to each other, and signal communication is performed between these control devices when necessary to carry out the process of transporting the trays.

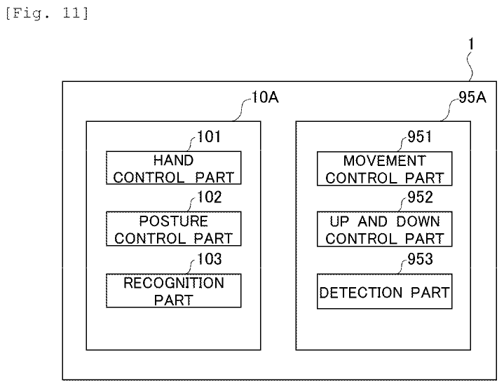

Functional parts implemented by executing the aforementioned control programs will now be described with reference to FIG. 11. The control device 10A of the robot 10 has, as functional parts, a hand control part 101, a posture control part 102, and a recognition part 103. The hand control part 101 is a functional part that controls opening and closing of the hand unit 60 of each arm unit 50. In the system according to this embodiment, as described above, the tray to be held is always positioned at the predetermined tray holding position in the housing rack 70. At this position, the tray is placed in a state in which it is supported on the tray rests 80 of the lift devices of the housing rack 70. Thus, the tray positioned at the tray holding position is kept in a regular state. Therefore, the hand control part 101 may execute the opening and closing control of the hand units 60 to hold the tray immediately after the completion of position control of the hand units 60 by the posture control part 102 (which will be described below).

The posture control part 102 is a functional part that controls the posture of the robot 10. In particular, the posture control part 102 executes the posture control for positioning the hand units 60 to hold the tray positioned at the tray holding position in the housing rack 70 and the posture control for taking out the tray after holding it. In this case also, the tray to be held is always positioned at the predetermined tray holding position in the housing rack 70, and therefore, it is not necessary to specifically recognize the state and the position of the tray using a camera or other device and execute the posture control for the robot 10 based on the recognition, but the posture of the robot 10 may be controlled in such a way as only to bring the hand units 60 to the tray holding position. Therefore, the control by the posture control part 102 is simple. The recognition part 103 is a functional part that recognizes the presence of the tray to be held at the tray holding position. The processing of this recognition is executed based on a sensor signal sent from a detection part 953, which will be described later. Control by the posture control part 102 is executed after the presence of the tray at the tray holding position is recognized by the recognition part 103.

The control device 95A of the housing apparatus 95 has, as functional parts, a movement control part 951, an up and down control part 952, and the detection part 953. The movement control part 951 is a functional part that executes control relating to movement of the transport system 1 by the truck 90. For example, to move the transport system 1 from a place at which trays are loaded into it to the destination of transport, the movement control part 951 controls steering and driving of the drive wheels 92 of the truck 90. The truck 90 is equipped with a GPS device for determining the present location of the truck 90, and the movement control part 951 may control the truck 90 based on a sensor signal of the GPS device. Alternatively, the movement control part 951 may control the truck 90 based on a control signal sent from an external device.

The up and down control part 952 is a functional part that controls the up and down movement of the lift devices of the housing rack 70. In particular, the up and down control part 952 controls the up and down movement of the lift devices so as to position a tray to be held at the tray holding position. The housing rack 70 is provided with a proximity sensor or the like (not shown), and the up and down control part 952 can detect the presence or absence of a tray on each tray rest 80. The actuator 74 is provided with an encoder, and the up and down control part 952 can determine where each tray rest 80 is located based on a sensor signal of the encoder. The up and down control part 952 controls the up and down movement of the lift devices using these sensor signals. The detection part 953 is a functional part that detects the presence of the tray to be held (i.e. the upper most tray in the housing rack 70) at the tray holding position. Signals generated by detection executed by the detection part 953 is passed to the recognition part 103 of the control device 10A.

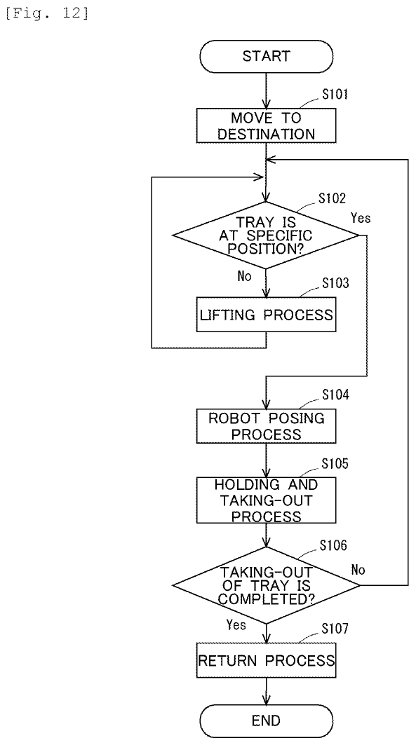

Next, the tray transport process performed by the transport system 1 will be described with reference to FIG. 12. FIG. 12 is a flow chart of the transport process. The execution of the transport process is triggered by a command to transport a plurality of trays to a certain destination sent to the transport system 1. In the following description, it is assumed that a plurality of trays are being housed in the housing rack 70. Firstly, in step S101, the movement control part 951 executes the processing of moving the transport system 1 to the destination. Information about the destination has already been supplied to the transport system 1.

Then, in step S102, it is determined whether or not the tray to be held located uppermost is positioned at the tray holding position as the specific position. This determination is made by the recognition part 103 on the basis of the state of the trays in the housing rack 70 determined by the detection part 953. If an affirmative determination is made in step S102, the process proceeds to step S104. If a negative determination is made in step S102, the process proceeds to step S103. In step S103, the up and down control part 952 executes a lifting process for the two lift devices in the housing rack 70. Specifically, the up and down control part 952 controls driving of the actuator 74 so as to bring the uppermost tray to the tray holding position. In step S104, the posture control part 102 executes posing of the robot 10 to position the hand units 60 relative to the tray to be held. As described above, the housing apparatus 95 and the robot 10 in the transport system 1 are coupled integrally, and the tray holding position is a known position relative to the robot main body 30 of the robot 10. Therefore, the posture control part 102 can do posing of the robot 10 easily and precisely.

After the hand units 60 are positioned relative to the tray by the aforementioned posing, the hand control part 101 executes the processing of holding the tray in step S105. Then, the hand control part 101 executes the processing of taking out the tray held by the hand units 60 from the housing rack 70. In this taking-out process, the knee joint unit 33 and the under-waist joint 34 are used. It is possible to lift the tray held by the hand units 60 by cooperative operations of these joint units without changing the posture of the upper body of the robot 10, in particular the posture of the arm units 50 that are holding the tray. This greatly contributes to stable taking-out of the tray. After the tray is taken out from the housing rack 70, the upper body of the robot 10 is rotated in the yaw direction at the hipbone unit 15 by the actuator for the waist yaw axis provided in the hipbone unit 15 while keeping its posture. This also greatly contributes to stable taking-out of the tray.

In step S106, it is determined whether taking-out of the tray from the housing rack 70 has been completed. This determination may be made by the recognition part 103 on the basis of the state of the tray in the housing rack 70 detected by the detection part 953. If an affirmative determination is made in step S106, the process proceeds to step S107. If a negative determination is made in step S106, the processing of step 102 onward is executed again. In step S107, the movement control part 951 executes the processing of moving the transport system 1 to a specific home place. Information about the home place may be prepared in advance. Alternatively, information about a place where loading of the housing apparatus 95 with objects to be transported next is performed may be supplied to the transport system 1 from an external device as information about the home place.

### <Modification>

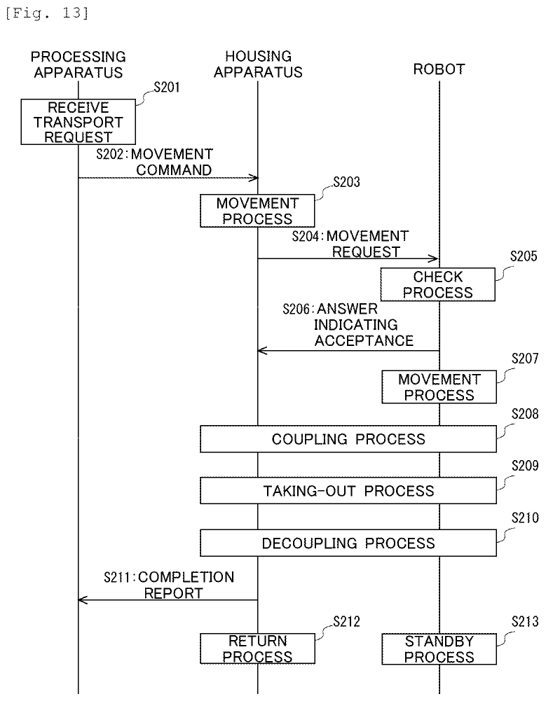

A modification of the object transport process performed by the transport system 1 will be described with reference to FIG. 13. In this modification, the housing apparatus 95 and the robot 10 in the transport system 1 are configured such that they can be coupled to and decoupled from each other, and the housing apparatus 95 and the robot 10 are configured to be cable of moving autonomously. For example, the truck 90 described in the above description of the embodiment is provided for each of the housing rack 70 and the robot 10 on their bottoms to enable the housing apparatus 95 and the robot 10 to move autonomously. In this case, the housing apparatus 95 is configured to implement the movement control part 951, the up and down control part 952, and the detection part 953 shown in FIG. 11, and the robot 10 is configured to implement a movement control part for controlling autonomous movement of the robot 10 in addition to the hand control part 101, the posture control part 102, and the recognition part 103. Integration of the housing apparatus 95 and the robot 10 is achieved by coupling the trucks 90 of them to each other. This enables communication of information between the housing apparatus 95 and the robot 10. After the integration, their autonomous movement may be performed under unified control executed by the movement control part 951 of the housing apparatus 95 or the movement control part of the robot 10.

As illustrated in FIG. 13, the transport system 1 includes a processing apparatus. The processing apparatus is a server apparatus, which sends commands that are necessary in the object transport process to the housing apparatus 95 and the robot 10. The processing apparatus, the housing apparatus 95, and the robot 10 are electrically connected through a network so that they can communicate with each other. The transport system 1 may include another housing apparatus.

The processing apparatus receives a request for transport of an object (e.g. a tray on which food and drink is placed) from a user (the processing of step S201). This request for transport includes information about the kind and the number of objects to be transported and the destination of transport. The processing apparatus receives the request for transport and sends a movement command to the housing apparatus 95 to cause it to move to the given destination after the requested object is loaded into the housing rack 70 (the processing of step S202). At this time, the housing apparatus 95 and the robot 10 are in a separated state. After receiving the movement command, the housing apparatus 95 is loaded with the object to be transported in its housing rack 70 at a specific place and then moves to the destination as requested (the processing of step S203).

While the housing apparatus 95 is moving in performing the above-described movement process, the housing apparatus 95 sends a movement request to the robot 10 to request it to move to the given destination of transport (the processing of step S204). In other words, the housing apparatus 95 sends the movement request to the separated robot 10 so that the robot 10 can do the taking-out operation at the destination to which the housing apparatus 95 will transport the object. There may be cases where the robot 10 is doing the taking-out operation for a housing apparatus other than the housing apparatus 95 that has sent the movement request in step S204. In view of this, when receiving the movement request, the robot 10 executes the processing of determining whether it can fulfill the request in step S205. If it is determined that the robot 10 can do the taking-out operation, the robot 10 sends an answer indicating the acceptance of the request to the housing apparatus 95 in step S206 and starts to move to the designated destination of transport (the processing of step S207). Alternatively, the robot 10 may receive the movement request from the processing apparatus.

After the housing apparatus 95 and the robot 10 come to the destination of transport, the operation of coupling the trucks of them is performed in step S208, so that the housing apparatus 95 and the robot 10 are coupled into an integral state substantially the same as that illustrated in FIG. 1. Then, the processing of holding and taking out the object is performed to take out the object housed in the housing apparatus 95 by the robot 10 at the destination of transport (the processing of step S209). The processing of step S209 is substantially the same as the processing of steps S102 through S106 in FIG. 12. After the completion of the processing of taking out the object, the processing of decoupling the housing apparatus 95 and the robot 10 from each other is performed (the processing of step S210), so that the housing apparatus 95 and the robot 10 become autonomously movable again. At the time when the decoupling is completed, the housing apparatus 95 sends a notification reporting the completion of the process relating to the transport request received in step S201 to the processing apparatus (the processing of step S211).

Thereafter, the housing apparatus 95 returns to a specific home place, where it waits for the next request sent from the processing apparatus (the processing of step S212). Likewise, the robot 10 enters a standby state to wait for the next movement request for the taking-out operation (the processing of step S213). The robot 10 in the standby state can accept a movement request sent from any housing apparatus 95 included in the transport system 1.

By the above-described transport process, the robot 10 can be coupled to housing apparatuses 95 that require the operation of taking out objects one after another to provide the taking-out operation. Therefore, the rate of operation of the robot 10 can be enhanced, and the transport system 1 can achieve efficient transport of objects. Since the housing apparatus 95 is being separated from the robot 10 while moving to the destination of transport, the energy consumption in moving can be reduced.

### REFERENCE SIGNS LIST

1: transport system
10: robot
10A: control device
30: robot main body
33: knee joint unit
34: under-pelvis joint unit
35: leg unit
50: arm unit
60: hand unit
62: first frame
65: second frame
66: slide member (slide part)
70: housing rack
74: actuator
77: chain
80: tray rest
81: table plate
90: truck
95: housing apparatus
95A: control device

1. A transport system comprising:
a manipulator apparatus having a hand unit capable of holding an object; and
a housing apparatus having a housing unit capable of housing a plurality of said objects,
wherein the manipulator apparatus is configured to be capable of controlling the position of the hand unit relative to a manipulator body unit that constitutes a main body of the manipulator apparatus,
the housing apparatus is configured to bring the objects housed in the housing unit one by one to a specific position in the housing apparatus accessible for the hand unit,
the manipulator apparatus and the housing apparatus are configured to be capable of moving as a unit in a state in which the manipulator body unit and the housing apparatus are coupled with each other,
the specific position is set as a known position relative to the manipulator body unit in the state in which the manipulator body unit and the housing apparatus are coupled with each other to make the manipulator apparatus and the housing apparatus integral.

2. A transport system according to claim 1, wherein the housing unit comprises:
a plurality of table parts on which the plurality of objects are arranged along the vertical direction;
a driver that drives the plurality of table parts along the vertical direction; and
a controller that controls the driver in such a way as to position the uppermost object located uppermost among the objects placed on the plurality of table parts to the specific position, when the objects are placed on at least one of the plurality of table parts.

3. The transport system according to claim 1, wherein the manipulator apparatus comprises:
a robot main body constituting the manipulator body unit;
a first arm unit having a first hand unit constituting a first example of the hand unit, the first arm unit being configured to be capable of controlling the position of the first hand unit relative to the robot main body; and
a second arm unit having a second hand unit constituting a second example of the hand unit, the second arm unit being configured to be capable of controlling the position of the second hand unit relative to the robot main body,
wherein the robot main body has an up-and-down joint unit capable of causing the first arm unit and the second arm unit to move up and down while keeping their postures.

4. A transport system according to claim 3, wherein the robot main body has a yaw axis joint unit capable of rotating the first arm unit and the second arm unit about a yaw axis while keeping their postures.

5. A transport system according to claim 1, wherein
the manipulator body unit and the housing apparatus are configured such that they can be coupled to and decoupled from each other,
the transport system further comprises a processing apparatus that sends a control signal to the housing apparatus so as to cause the housing apparatus to move between a loading place at which the object to be housed in the housing unit is loaded into the housing unit and a destination of transport to which the object housed in the housing unit is to be transported,
the manipulator apparatus receives information about the destination of transport from the processing apparatus or the housing apparatus, moves to the destination of transport, and couples the manipulator body unit to the housing apparatus, and
after completing taking-out of the object housed in the housing unit, the manipulator apparatus decouples the manipulator body unit and the housing apparatus from each other.
